(19) United States
(12) Patent Application Publication
(10) Pub. No.: US 2011/0148783 A1
(43) Pub. Date: Jun. 23, 2011

(54) DISPLAY APPARATUS

(76) Inventor: Tsung-Ting LEE, Chiayi County (TW)

(21) Appl. No.: 12/786,802

(22) Filed: May 25, 2010

(30) Foreign Application Priority Data
Dec. 21, 2009 (TW) 098143953

(51) Int. Cl. G06F 3/038; G06F 3/041

(52) U.S. Cl. 345/173; 345/205

(57) ABSTRACT

A display apparatus includes a display module and a covering material. The covering material at least covers an edge of the display module and has at least a connection portion disposed adjacent to the edge.

### CROSS REFERENCE TO RELATED APPLICATIONS

This Non-provisional application claims priority under 35 U.S.C. §119(a) on Patent Application No(s). 098143953 filed in Taiwan, Republic of China on Dec. 21, 2009, the entire contents of which are hereby incorporated by reference.

### BACKGROUND OF THE INVENTION

1. Field of Invention

The invention relates to a display apparatus.

2. Related Art

Because flat panel displays (FPDs) are developed progressively with advantages such as compact structure, low power consumption, and non-radiation, they are widely applied to various electronic products and gradually take the place of cathode ray tube (CRT) display apparatuses.

However, the development of display apparatuses gradually becomes monotonous without variety. For example, the present display apparatus mainly consists of a single display screen, and the display apparatus can not physically connect to other display apparatuses or touch panels. Hence, the present display apparatus can not satisfy the demand of multiple applications.

Therefore, it is an important subject to provide a display apparatus that can be more utility and fit the marketing demand to improve competitiveness of products.

### SUMMARY OF THE INVENTION

In view of the foregoing subject, an object of the invention is to provide a solar cell that can adapt to various weather conditions, and accept the light of various wave bands, thereby improving photoelectric converting efficiency.

In view of the foregoing subject, the invention is to provide a display apparatus that can be more utility to improve competitiveness of products.

To achieve the above, a display apparatus according to the invention includes a display module and a covering material. The covering material at least covers an edge of the display module and has at least a connection portion disposed adjacent to the edge.

As mentioned above, in the display apparatus according to the invention, the covering material covers an edge of the display module and has a connection portion disposed adjacent to the edge, so that other devices or apparatuses can easily connect to the display apparatus through the connection portion. Therefore, the display apparatus can be more utility and fitter for industry application and marketing demands so as to provide improved competitiveness.

### BRIEF DESCRIPTION OF THE DRAWINGS

The invention will become more fully understood from the detailed description and accompanying drawings, which are given for illustration only, and thus are not limitative of the present invention, and wherein:

FIGS. 1A to 1D are schematic diagrams of various aspects of a first embodiment of the invention;

FIGS. 2A to 2G are schematic diagrams of various aspects of a second embodiment of the invention; and

FIGS. 3A to 3C are schematic diagrams of various aspects of a third embodiment of the invention.

### DETAILED DESCRIPTION OF THE INVENTION

The present invention will be apparent from the following detailed description, which proceeds with reference to the accompanying drawings, wherein the same references relate to the same elements.

### First Embodiment

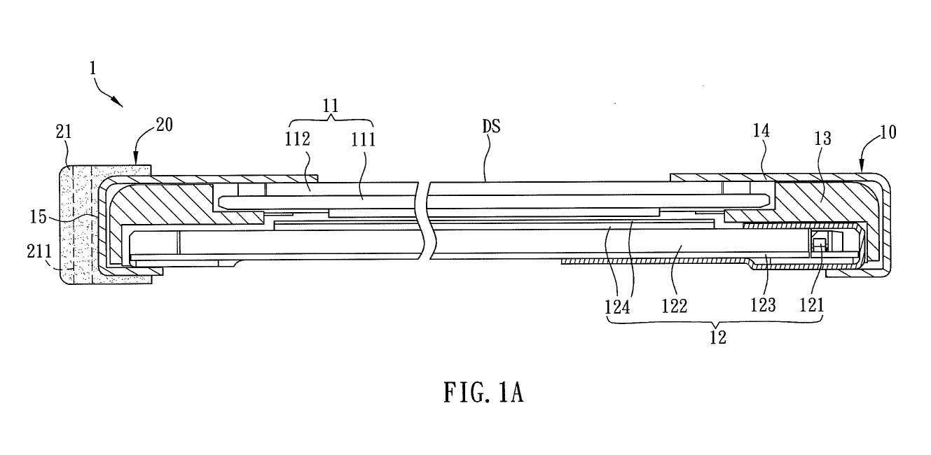

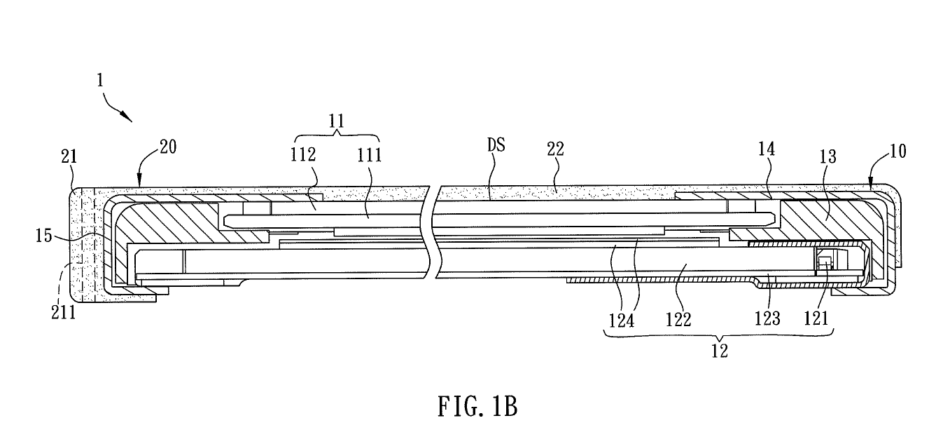

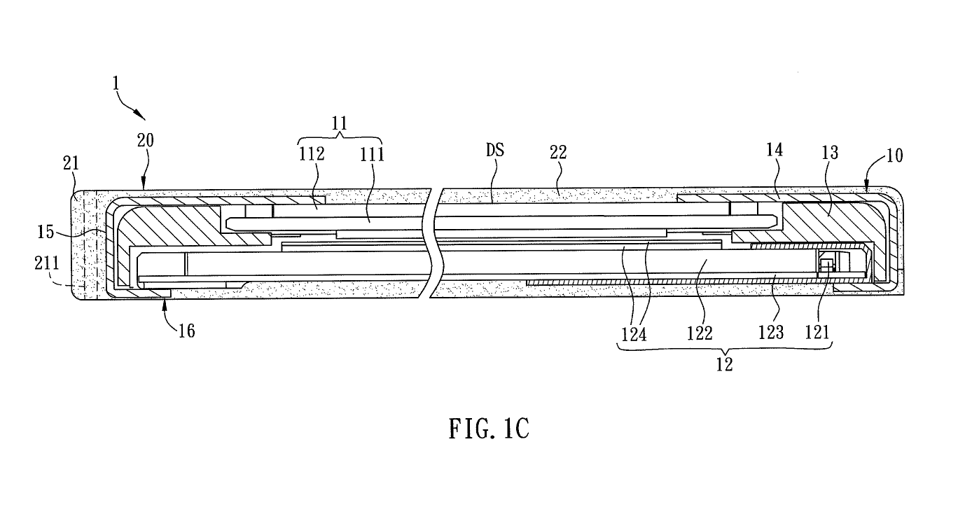

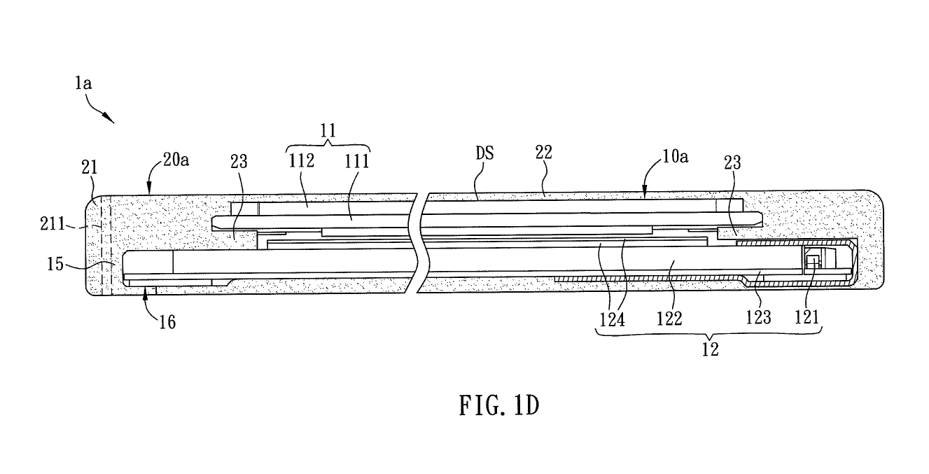

As shown in FIG. 1A, a display apparatus according to a preferred embodiment of the invention includes a display module 10 and a covering material 20. The display module 10 can be a liquid crystal display (LCD) module, an organic light emitting diode (OLED) display module, a light emitting diode (LED) display module, a plasma display module, an electronic paper (e-paper) display module or other kind of display modules. Here, the display module 10 is an LCD module for example.

The display module 10 has a display panel 11 and a backlight unit 12. The display panel 11 and the backlight unit 12 are disposed oppositely. A plastic frame 13 is disposed and extended to a location between the display panel 11 and the backlight unit 12 for supporting the display panel 11 and defining the interval between the display panel 11 and the backlight unit 12. The display panel 11, the backlight unit 12 and the plastic frame 13 are disposed in a frame 14.

The display panel 11 includes a thin film transistor (TFT) substrate 111 and a color filter (CF) substrate 112, which are disposed oppositely, and a liquid crystal layer is disposed therebetween. The backlight unit 12 includes a lighting unit 121, a light guiding plate 122, a reflective element 123 and a set of optical films 124. Because these elements are developed well in the prior art, the detailed descriptions are omitted here. To be noted, the LCD module as shown in FIG. 1 is just for illustration as an example, and not for limiting the scope of the invention. The display module 10 has a display surface DS, which is located at the CF substrate 112 in the embodiment. The display surface DS means the last physical surface through which the light emitted from the backlight unit 12 passes before reaching human eyes. But, to be noted, the size of the display surface DS is limited to the effective display area bounded by the frame 14. In the embodiment, the display surface DS is the exterior surface of the polarizing plate of the display panel 11.

The covering material 20 at least covers an edge 15 of the display module 10, and has at least a connection portion 21 disposed adjacent to the edge 15. The covering material 20 may cover the edge 15 of the display module 10 by insert molding or other kind of injection molding. The edge 15 of the display module 10 can be any edge of the display module 10, and here it means the left edge of the display module 10 when the display surface DS faces upwards. The covering material 20 can be flexible, and it can be made of transparent polymer such as thermoplastic polymer (e.g. polycarbonate (PC), Poly(methyl methacrylate) (PMMA), or composite plastics).

The connection portion 21 of the covering material 20 can have various configurations such as a protrusion, a depression, a screw hole, or a through hole. In this embodiment, the connection portion 21 has a through hole 211 for example. The connection portion 21 can be used to connect to other devices or apparatuses to make the product more utility.

The covering material 20 covers the edge 15 of the display module, and in addition, it can cover the display surface DS and/or a rear surface of the display module 10, which is opposite to the display surface DS.

As shown in FIG. 1B, the covering material 20 further covers the display surface DS of the display module 10. A light-permeable portion 22 of the covering material 20 covers the display surface DS. The area of the light-permeable portion 22 is larger than that of the display surface DS, and this means the light-permeable portion 22 completely covers the display surface DS, and the light of the display module 10 can still come out through the light-permeable portion 22. The light-permeable portion 22 can be shaped like a sheet or have a curved surface, and here the exterior surface of the light-permeable portion 22 is a planar surface for example. Besides, the light-permeable portion 22 (or the portion of the covering material 20 covering the display surface DS) is seamless, and this means the light-permeable portion 22 can be configured with a continuous surface or have no vertical gap. Here, the light-permeable portion 22 is configured with a continuous surface without vertical gap. So, the display surface DS is completely covered by the light-permeable portion 22. Therefore, foreign objects, e.g. dust and liquid, can not enter into the display module 10 so as to maintain the display efficiency.

In addition, as shown in FIG. 1C, the covering material 20 further covers a rear surface 16 of the display module 10, which is opposite to the display surface DS. Accordingly, the covering material 20 can be regarded as the exterior housing of the display apparatus 1 to protect the display module 10.

As shown in FIG. 1D, a display apparatus 1a of another aspect, which is different from the aspects mentioned above, does not configured with the frame and the plastic frame, because the covering material 20a can take the place of the frame 14 and the plastic frame 13. The covering material 20a not only covers the display surface DS and an edge 15 of the display module 10a, but also extends to a location between the display panel 11 and the backlight unit 12 for defining the interval therebetween, thereby replacing the plastic frame. In practice, the covering material 20a can be made separately by injection molding, and then assembled with the display panel 11 and the backlight unit 12. Otherwise, one of the display panel 11 and the backlight unit 12 can be put in a mold and then covered by the covering material 20a through injection molding to form a semi-finished product. Then, the semi-finished product and the other one of the display panel 11 and the backlight unit 12 are put in another mold to manufacture the display apparatus 1a by the second injection molding.

### Second Embodiment

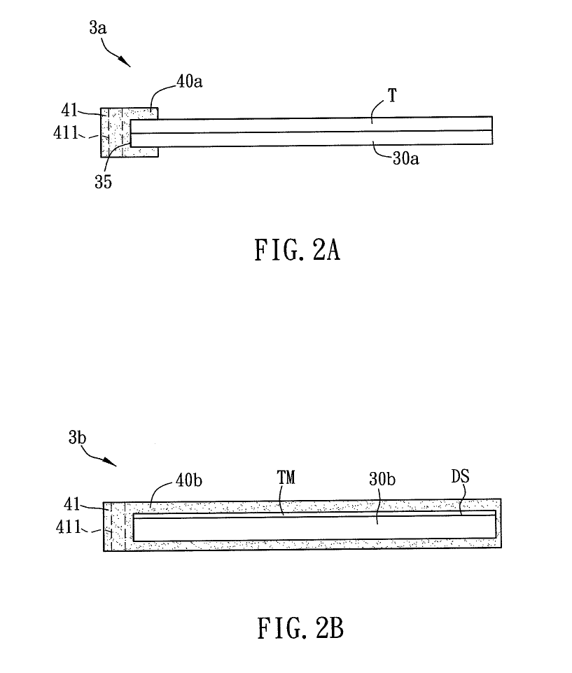

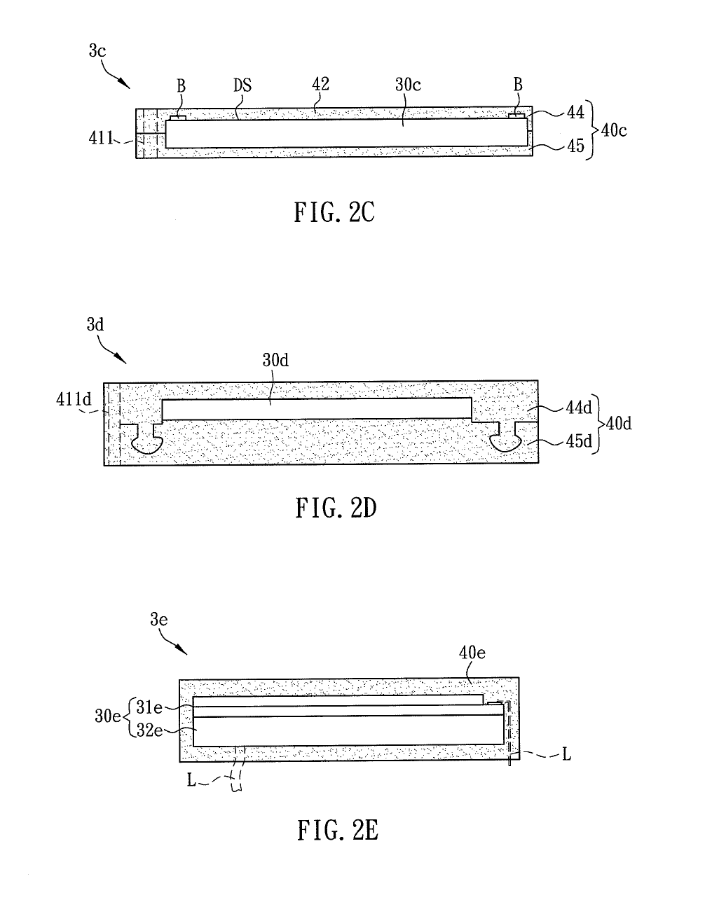

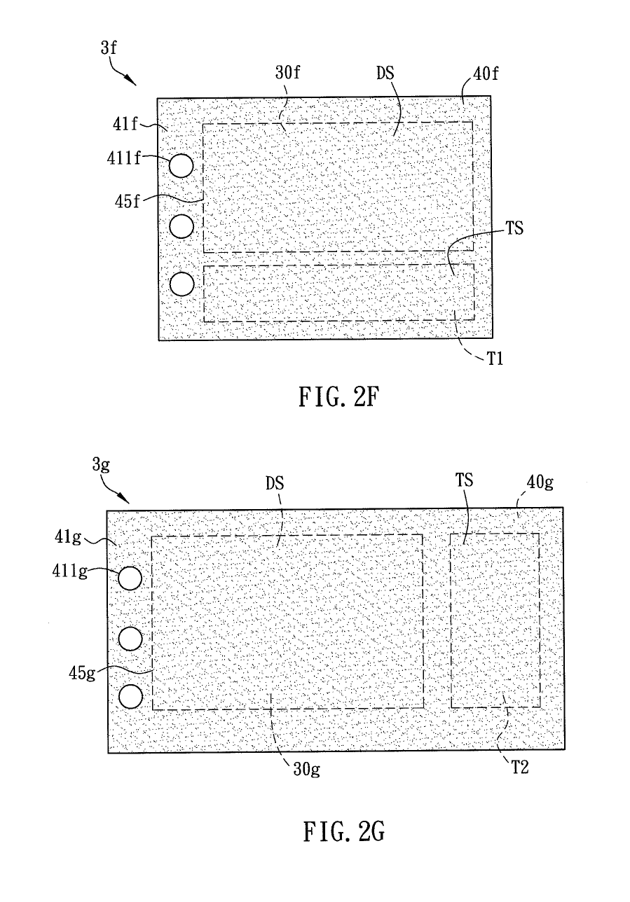

The invention can have various aspects with respect to the connection of the display module and the covering material, and they are illustrated in FIGS. 2A to 2G for example.

As shown in FIG. 2A, the display apparatus 3a includes a display module 30a and a covering material 40a. The covering material 40a covers an edge 35 of the display module 30a and has at least a connection portion 41 disposed adjacent to the edge 35. The display apparatus 3a further includes a touch panel T, which is disposed substantially parallel to the display module 30a, and the covering material 40a further covers an edge of the touch panel T. The touch panel T can be, for example, strain gauge type, resistive type, capacitive type, infrared type, surface acoustic wave type, optical imaging type or other type of touch panel. Because the covering material 40a can be made of elastic or light-permeable material, the covering material 40a will not affect the function of the touch panel T.

As shown in FIG. 2B, the display apparatus 3b can further include a light-permeable medium TM, which is disposed between the covering material 40b and the display module 30b. The refractive index of the light-permeable medium TM is between that of the covering material 40b and that of the display module 30b. The light-permeable medium TM can be a colloid or a fluid. By disposing the light-permeable medium TM, the amount of the reflected light can be reduced to improve display quality.

As shown in FIG. 2C, the covering material 40c of this aspect, which is different from the aspects as mentioned above, has a plurality of sub-portions 44 and 45, and the sub-portion 44 has a light-permeable portion 42. The sub-portions 44 and 45 can be connected to each other by locking, adhering, embedding, injection molding, or their combinations. Alternatively, each of the sub-portions 44 and/or 45 may have at least a depression and at least a protrusion, which can match one another, so that the sub-portions 44 and 45 can be connected to each other through the depression and protrusion. Here, the sub-portions 44 and 45 are connected with each other, for example, by adhering and injection molding.

Besides, the display apparatus 3c can further include a buffer element B, which is disposed between the covering material 40c and the display module 30c. In this case, the buffer element B is disposed between the display surface DS of the display module 30c and the covering material 40c, and the buffer element B needs to be disposed in a non-display area of the display module 30c. The buffer element B can be, for example, a twin adhesive, a foam, a rubber, a plastics, or the likes having buffering function. Of course, if the buffer element B is permeable to light, it can be disposed in the display area of the display module 30c.

FIG. 2D shows a display apparatus 3d of another aspect, and in this aspect, the covering material 40d has two sub-portions 44d and 45d, each of which has at least a protrusion and/or at least a depression matching each other. Thus, the sub-portions 44d and 45d can connect to each other by the protrusion and the depression.

As shown in FIG. 2E, a display apparatus 3e of another aspect includes a display module 30e and a covering material 40e. The display module 30e has a display panel 31e and a backlight unit 32e, and further has at least an electric connection element L. The electric connection element L is electrically connected with the display module 30e and extending out of the covering material 40e. The electric connection element L can be a wire, a connector, or other elements with the function of electric connection. The electric connection element L here is a wire for example. The electric connection element L is electrically connected with the display panel 31e and the backlight unit 32e, and extending out of the covering material 40e for electrically connecting to the external electronic devices, e.g. a driving circuit board. Otherwise, if the electric connection element L is a connector, the external electronic device can be inserted into the connector directly.

FIGS. 2F and 2G are top view diagrams schematically showing the display apparatuses 3f and 3g, respectively. As shown in FIG. 2F, the display apparatus 3f includes a display module 30f and a touch panel T1. The touch panel T1 is disposed adjacent to the display module 30f and has a touch surface TS. The covering material 40f covers the display surface DS and the touch surface TS. The covering material 40f covers an edge 35f of the display module 30f, and has a connection portion 41f disposed adjacent to the edge 35f. The connection portion 41f has through holes 411f. The connection portion 41f can connect to other devices. In addition, as shown in FIG. 2G the display apparatus 3g includes a display module 30g and a touch panel T2. The touch panel T2 is disposed adjacent to the display module 30g and has a touch surface TS. The covering material 40g covers the display surface DS and the touch surface TS. The covering material 40g covers an edge 35g of the display module 30g, and has a connection portion 41g disposed adjacent to the edge 35g. The connection portion 41g has through holes 411g. The connection portion 41g can connect to other devices. FIGS. 2F and 2G show that the covering material of this embodiment can cover a display module and a touch panel. Of course, the illustration of FIGS. 2F and 2G is just for instance, and not for limiting the scope of the invention. Alternatively, the covering material of the invention can cover two or more display modules that are merely for display; or, the covering material can cover a touch display apparatus having a touch panel, and a display module; or, the covering material can cover two touch display apparatuses which are on the same plane level and have two touch panels respectively.

### Third Embodiment

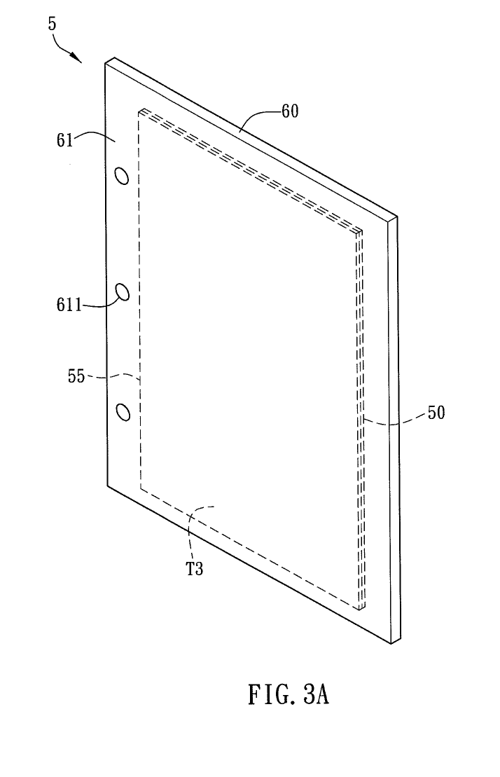

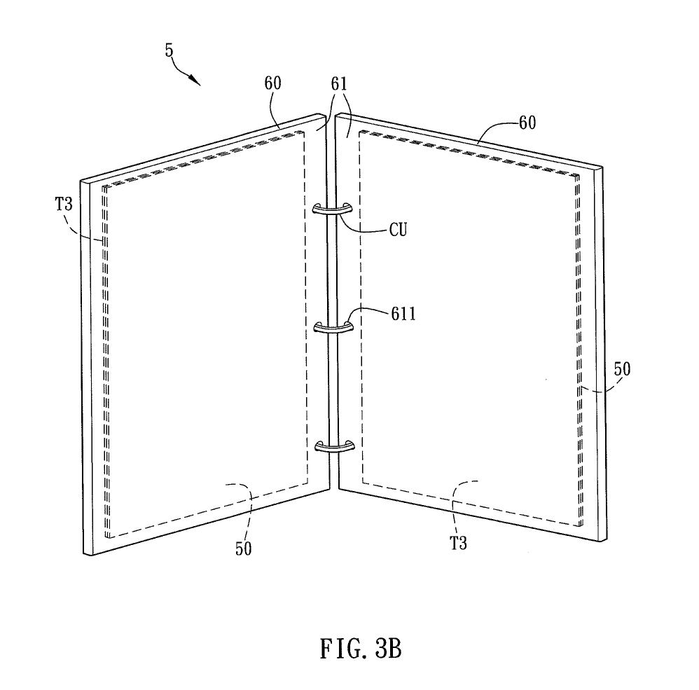

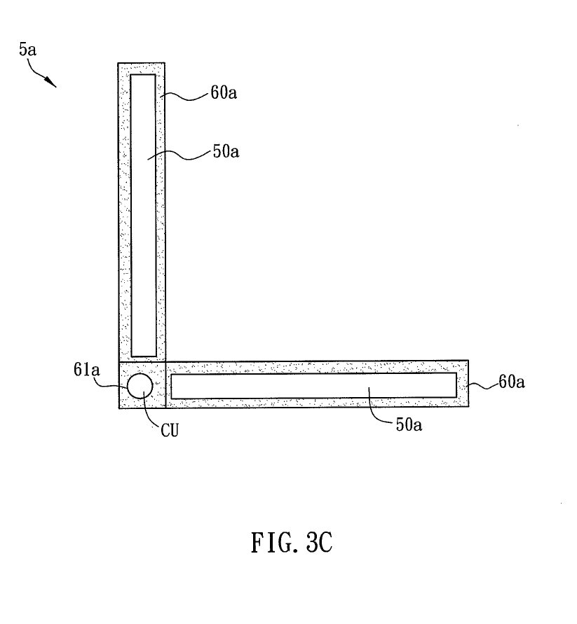

The display module and the display apparatus of the invention can have various applications, which are described and shown in FIGS. 3A to 3C for example.

As shown in FIG. 3A, the display apparatus 5 includes a display module 50, a touch panel T3 and a covering material 60. The display module 50 and the touch panel T3 are disposed oppositely, and the covering material 60 covers the display module 50 and the touch panel T3. The covering material 60 further covers an edge 55 of the display module 50 and the touch panel T3, and has a connection portion 61 disposed adjacent to the edge 55. The connection portion can be configured with any of various structures, such as a protrusion, a depression, a screw hole and a through hole. The connection portion 61 here has a through hole 611, for example. The connection portion 61 can be used to connect to other devices or apparatuses, thereby making the product more utility.

As shown in FIG. 3B, the display apparatus 5 further includes a connection unit CU, which is connected with the connection portion 61. The connection unit CU can have a pivot, an O-ring, a spiral ring, a rope, a line, an adhesive or the like capable of connecting. Here an O-ring is instanced as the connection unit CU. Besides, the connection unit CU also connects to a connection portion 61 of another covering material 60, so that a plurality of the display modules, at least an edge of each of which is covered by the covering material 60, are connected to each other to make the product more utility. The display modules can be different, and for example, one of them is an LCD module, and the other is an e-paper display module.

As shown in FIG. 3C, a pivot is instanced as the connection unit CU of the display apparatus 51. The pivot connects to the connection portions 61a to make the display modules 50a rotatable with each other. Otherwise, the connection unit CU can connect to a display module and a touch panel.

To be noted, the features of the all embodiments above can be freely combined to put into practice, and detailed descriptions are omitted here.

In summary, in the display apparatus according to the invention, the covering material covers an edge of the display module and has a connection portion disposed adjacent to the edge, so that other devices or apparatuses can easily connect to the display apparatus through the connection portion. Therefore, the display apparatus can be more utility and fitter for industry application and marketing demands so as to provide improved competitiveness.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A display apparatus, comprising:
a display module; and
a covering material at least covering an edge of the display module and having at least a connection portion disposed adjacent to the edge.

2. The display apparatus as recited in claim 1, wherein the display module is a liquid crystal display module, an organic light emitting diode display module, a light emitting diode display module, a plasma display module, or an electronic paper display module.

3. The display apparatus as recited in claim 1, wherein the covering material covers the display module by insert molding or injection molding.

4. The display apparatus as recited in claim 1, wherein the covering material includes thermoplastic polymer.

5. The display apparatus as recited in claim 1, wherein the connection portion includes at least a through hole.

6. The display apparatus as recited in claim 1, further comprising:
a connection unit connected with the connection portion.

7. The display apparatus as recited in claim 6, further comprising:
another display module or a touch panel connected with the display module through the connection unit.

8. The display apparatus as recited in claim 6, wherein the connection unit includes a pivot, an O-ring, a spiral ring, a rope, a line segment, or an adhesive agent.

9. The display apparatus as recited in claim 1, wherein the display module has a display surface, and a light-permeable portion of the covering material covers the display surface.

10. The display apparatus as recited in claim 9, wherein the covering material further covers a rear surface of the display module that is opposite to the display surface.

11. The display apparatus as recited in claim 9, wherein the exterior surface of the light-permeable portion is substantially a planar surface or a curved surface.

12. The display apparatus as recited in claim 9, further comprising:
a light-permeable medium disposed between the light-permeable portion of the covering material and the display module.

13. The display apparatus as recited in claim 12, wherein the refractive index of the light-permeable medium is between that of the covering material and that of the display module.

14. The display apparatus as recited in claim 12, wherein the light-permeable medium is a colloid or a fluid.

15. The display apparatus as recited in claim 1, further comprising:
a buffer element disposed between the covering material and the display module.

16. The display apparatus as recited in claim 15, wherein the buffer element is a twin adhesive, a foam, a rubber, or a plastics.

17. The display apparatus as recited in claim 1, further comprising:
an electric connection element electrically connected with the display module and extending out of the covering material.

18. The display apparatus as recited in claim 17, wherein the electric connection element is a wire or a connector.

19. The display apparatus as recited in claim 1, wherein the covering material consists of a plurality of sub-portions.

20. The display apparatus as recited in claim 19, wherein the sub-portions are connected to each other by locking, adhering, embedding, injection molding, or their combinations.

21. The display apparatus as recited in claim 19, wherein each of the sub-portions has at least a depression and at least a protrusion for connecting with other sub-portions.

22. The display apparatus as recited in claim 1, further comprising:
a touch panel disposed adjacent to the display module or opposite to the display module, wherein the covering material further covers an edge of the touch panel.

23. The display apparatus as recited in claim 22, wherein the touch panel is of strain gauge type, resistive type, capacitive type, infrared type, surface acoustic wave type, electromagnetic type, or optical imaging type.

24. The display apparatus as recited in claim 1, wherein the display module comprising:
a display panel; and
a backlight unit disposed opposite to the display panel.

25. The display apparatus as recited in claim 24, wherein the covering material extends to a location between the display panel and the backlight unit for defining the interval between the display panel and the backlight unit.
